(19) United States
(12) Patent Application Publication
(10) Pub. No.: US 2011/0033598 A1
(43) Pub. Date: Feb. 10, 2011

(54) Edible Polymer Based Food System

(76) Inventors: Yachai Amornkul, Twinsburg, OH (US); Noel F. Galluch, Boston, NY (US); Praveen Upreti, Twinsburg, OH (US); Cheryl A. Smith, Lockport, NY (US); Michael Piatko, West Seneca, NY (US); John S. Roberts, Honeoye Falls, NY (US); Paula Lugar, Tonawanda, NY (US); Amanda Megan, East Amherst, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/796,956

(22) Filed: Jun. 9, 2010

Related U.S. Application Data
(60) Provisional application No. 61/185,415, filed on Jun. 9, 2009.

(51) Int. Cl. A23L 1/0524; A23L 1/0562; A23L 1/054; A21D 13/00

(52) U.S. Cl. 426/549; 426/577; 426/576

(57) ABSTRACT

A frozen or refrigerated food product is disclosed which comprises a polymer component, an egg component and water. The egg component comprises uncooked liquid eggs or egg substitutes.

### CROSS-REFERENCE TO RELATED APPLICATION

This application claims priority to U.S. Provisional application No. 61/185,415, filed on Jun. 9, 2009, the disclosure of which is incorporated herein by reference.

### FIELD OF THE INVENTION

The present invention relates generally to the field of a polymer based delivery/holding system for food items and more particularly to an edible polymer based delivery/holding system for egg based food items.

### DESCRIPTION OF RELATED ART

Currently the frozen egg based patties available in the market comprise cooked eggs. These patties are precooked and have to be reheated for use in food items. Further, these egg patties do not generally form an integral part of the food item in or on which they are used in the sense that they do not adhere to the base food item on which they are placed and therefore do not provide the functionality of ‘made from scratch’ product. Thus, there is a need for delivery/holding system for egg based foods which forms food items having uncooked egg components, which can be stored in frozen or refrigerated state in desired shapes and sizes and which still provide functionalities similar to a ‘made from scratch’ product.

### BRIEF SUMMARY OF THE INVENTION

The present invention provides a frozen or refrigerated food product comprising a polymer component, an egg component and water. The egg component comprises uncooked liquid eggs or egg substitutes.

### BRIEF DESCRIPTION OF THE DRAWINGS

FIG. 1 shows the food product, in solution and uncooked gelled patties, containing the indicated pectin concentrations.

### DETAILED DESCRIPTION OF THE INVENTION

The present invention provides a product in which egg based ingredients are incorporated into a polymer based delivery/holding system. The polymer based delivery/holding system allows the egg ingredients to be stored in an uncooked state at refrigeration or freezer temperatures. The product of the present invention comprises a polymer component; an egg component; water; optionally, flavor and/or texture enhancer (such as cheese sauce mix); and optionally, toppings. The product can be made into desired shape, size and thickness. In one embodiment, it is generally flat. While the words “Patty” or “Patties” are used sometimes herein to denote the product, these phrases are intended to cover all sizes, shapes and appearances of the product. In one embodiment, the present product can be folded into a layered food item prior to storage. All concentrations are indicated in weight percents unless indicated otherwise.

The polymer component is a combination of polymers (such as pectin, gelatin, xanthan gum, methocel, agar and the like). In one embodiment, the polymer component comprises pectin and a second polymer. The second polymer can be gelatin, xanthan, agar, methocel and the like. For example, the polymer component can be pectin and gelatin. In one embodiment, 1.5% pectin and 3% gelatin are used. In other embodiments, Pectin can be present as between 0.75 to 3.25%. For example, pectin can be 0.75, 1.0, 1.25, 1.5, 1.75, 2.5, 2.75, 3.0, or 3.25 wt % (and all values therebetween to the hundredth decimal point and all ranges therebetween), and gelatin can be present as up to 3.25%. For example, gelatin can be 0, 0.25, 0.5, 1.0, 1.25, 1.5, 1.75, 2.0, 2.25, 2.5, 2.75, 3.0 or 3.25 wt % (and all values therebetween to the hundredth decimal point and ranges therebetween). For example, in one embodiment, the gelatin is present between 0.25 to 3.25%. Additionally, or alternatively to gelatin, Xanthan gum can be present as up to 0.25%. For example, it can be 0, 0.05, 0.1, 0.15, 0.2, or 0.25 wt % (and all values to the hundredth decimal point and all ranges therebetween).

The polymers are selected to provide a system that results in flow characteristics such that the patty will be useable not only as a sandwich patty, but also as a flat bread (such as pizza) overlay—i.e., when cooked it will adhere to a surface. The present product can also be consumed by itself—without the need to be placed on or in another food item. The cooked product can be consumed as a single layered flat food item or can be folded onto itself and consumed. It is preferable to adjust the pH of the formulation at between 3 and 5 as this allows pectin to be more active. Thus, in various embodiments, the pH can be 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 or 5.0.

The egg component comprises uncooked liquid whole eggs, components of eggs (white or yolk) or egg substitutes. The liquid egg in the formulation is uncooked egg or egg portion. This is preferably pasteurized. The egg portion can be egg white, egg yolk or combination thereof. Alternatively, or additionally, egg substitutes can also be added. The liquid egg component is between 35 to 55%. In various embodiments, the egg component is 35, 36, 37, 38, 39, 40, 41, 42, 43, 44, 45, 46, 47, 48, 49, 50, 51, 52, 53, 54 or 55%. In particular embodiments, the egg component is 43, 44 or 45%. It is also possible to use egg powder which can be mixed with water to make up a mixture or solution equivalent to the liquid egg amounts described above.

In one embodiment, the product comprises pasteurized liquid eggs, polymers, whey, cheese, maltodextrin, modified starch, and pH controller.

The water is between 30 and 40%. In various embodiments, water is 30, 31, 32, 33,34, 35, 36, 37, 38, 39, 40, 41, 42, 43, 44, 45. In one embodiment, it is 35%. The amount of water can be adjusted so that the formulation flows properly in the mold or pan and it should spread properly and uniformly. Additionally, if there is too much water, it will take too long to bake and the food item (such as pizza) may burn before it bakes.

The formulation optionally contains a texture enhancer (such as a commercially available cheese sauce mix (such as Trio cheese Sauce mix)). Such cheese sauce mixes typically contain maltodextrin, starch, modified tapioca starch, whey, NFDM (non fat dry milk), sodium caseinate, cheddar cheese flavor, mono-diglyceride

The pH of the formulation is preferably adjusted to be between 3 and 5. A convenient method for adjusting the pH is by the addition of pHase. It was observed that a lower pH resulted in a better gel strength. This also made handling easier. In the absence of addition of the pHase, the pH of the formulation is around neutral.

### Method of Making the Patties

To prepare the patties, pectin and the second polymer are added to hot water which is at a temperature of at least 100° F. In one embodiment, the water temperature is between 100 and 200° F. and all integers therebetween in degrees F. In various embodiments, the water temperature is between 120 and 180, between 125 and 175° F., between 130 to 170° F., between 135 and 165° F., between 140 and 160° F., and between 145 and 155° F. In some particular embodiments, the water temperature is 140° F. The ingredients are mixed (such as with a bench top hand mixer on high setting or equivalent mixing speeds thereof) to provide high sheer mixing for 0.5 to 5 minutes. In specific embodiments, the high sheer mixing is done for about 1 minute (between 50 to 70 seconds).

After the high sheer mixing, the flavor and texture enhancer (cheese sauce) and the pH controller (pHase) are added. Then the liquid egg component and optionally cheese (such as Mozzarella, cheddar, Swiss, American or any other kind of cheese) are added and again the ingredients are subjected to high sheer mixing. The high sheer mixing is done as above, but the mixing or the temperature should not be such that denaturation of the egg white can occur.

After the mixing, the formulation is ready for being poured into desired portions and shapes. To obtain desired shapes, the formulation can be poured into shaped molds or pans. If the mold or pan is not shaped, a circular shape is generally obtained. The surface on which the formulation is poured may be a non-stick surface, a surface coated or sprayed with oil or a non-stick or a semi non-stick paper or surface (such as wax paper, plastic or aluminum foil).

After pouring the formulation onto a surface, optionally, toppings may be placed on the upper surface of the poured formulation. The toppings may be vegetable, fruit or meat, or cheese toppings. The toppings may slightly sink into the formulation. In another embodiment, the toppings are placed first on the pouring surface and then the formulation is poured on top of the toppings. In another embodiment, a combination of placing the toppings on the pouring surface, pouring the formulation, and placing additional toppings on top of the poured formulation can be carried out.

If only meats, vegetable and/or fruits have been placed below or above the formulation, cheese is now added on top. The cheese can be shredded cheese or other cheese formats. The poured formulation is then placed in a hot oven for a short time (such as between 30 to 60 seconds) such that only the surface gets heated so as to melt the cheese. However, preferably there should be no significant effect on the polymer or the egg component.

The product is then allowed to gel. The gelling can occur at room temperature, but will take a long time. It is preferable to gel the product by chilling it at refrigeration or freezer temperatures. For example, the product can be chilled at below 32° F. In various embodiments, the product can be chilled at between −30° F. to 0° F. In another embodiment, it is chilled for about between 5 to 15 minutes, such as for about 10 minutes (9, 10 or 11 minutes) at −10° F. When placed at below freezing temperatures, the product starts to set quickly.

After chilling, the product is now formed and can be removed from the mold or pan, optionally, cut into desired shapes and sizes, and processed to storage. In one embodiment, instead of chilling the product in a mold or pan, the formulation can be poured onto a surface on which it can be directly chilled. After the chilling step, the product can be stored in a refrigerator or freezer.

### Method of Use

For use in consumption, the patty can be taken out of the freezer or refrigerator, placed on or in a food item, such as a muffin, slice of bread, flat bread, pita, pizza base etc. or in a sandwich or calzone or flat bread (such as pizza etc.), breakfast sandwich, breakfast wrap, quesadilla and the like, and then cooked. Alternatively, the patty can simply be cooked and consumed without any other food item. The cooking can be done in a microwave oven, conventional oven, pan, skillet, grille, and the like.

An advantage of the present patty is that when it is cooked on a food item, it adheres to the base food item. Thus it is different than the egg patties (typically on muffins) available in fast food restaurants which do not adhere to the base and can easily slip out of the sandwich material. Because the present egg polymer patties adhere to the base, they are similar to a product prepared from scratch. Once baked, the egg patties are indistinguishable from “made from scratch” products.

Another advantage is that it has been observed that the currently available breakfast patties (such as muffin patties available in fast food restaurants) are stored frozen in a cooked form. Thus, the egg is cooked and then stored. The present product uses a polymer based delivery/holding system which holds the uncooked liquid egg components in desired shapes and sizes at ambient, refrigeration, and freezer temperatures, and allows them to be stored at these temperatures. The commercially available egg patties have to be reheated and this results in a product that is not fluffy. However, for the present product, it was observed that the cooked patty is light and fluffy. While not intending to be bound by any particular theory, it is considered that this may be due to the egg being cooked only once until the point of consumption. Because of the use of polymers, in the present invention, the egg component can be stored in a raw state, but held in a gelled format of the polymers

It is further believed that because of the particular combination of ingredients, the patties can be made into bigger sizes than would otherwise be possible. For example, circular patties of at least 12, 14 or 16 inches diameter can be made. Additionally, after the patty has gelled, it can be stored at ambient temperatures (room temperatures—generally between 68-75° F.), in a refrigerator or in a freezer.

### EXAMPLE 1

This example provides an illustration for the present formulation.

| INGREDIENT | wt |
|---|---|
| DESCRIPTION | PERCENT |
| Cheese sauce | 10 |
| Hot water | 34.7 |
| Pectin | 1.5 |
| Gelatin | 3 |
| Cheese | 7 |
| Liquid eggs | 43 |
| Salt | 0.3 |
| pHase | 0.5 |
| TOTAL | 100 |

The ingredients were mixed and processed as described above.

### EXAMPLE 2

The following experiment was performed to determine the effect of various gums in the formulation

| | | Baked appearance | |
|---|---|---|---|
| | Mixture solution | scores (1 = not | Adher- |
| | scores (1= thin, | acceptable, | ence |
| | 3 = medium, | 3 = acceptable, | on the |
| Test | 5 = thick) | 5 = good) | crust |
| Eggs (43%) + Gelatin | 1 | 2 | Yes |
| (3%) + Water (54%) | | | |
| Eggs (43%) + Pectin | 3 | 5 | Yes |
| (1.5%) + Water (55.5%) | | | |
| Eggs (43%) + Gelatin | 4 | 4 | Yes |
| (3%) + Pectin | | | |
| (1.5%) + Water (52.5%) | | | |
| Eggs (43%) + Methocel | 1 | 2 | Yes |
| (1.5%) + Water (55.5%) | | | |
| Eggs (43%) + Methocel | 1 | 2 | Yes |
| (1.5%) + Gelatin | | | |
| (3%) + Water (52.5%) | | | |
| Eggs (43%) + Xanthan | 1 | 3 | Yes |
| (1.5%) + Water (55.5%) | | | |
| Eggs + (43%) Xanthan | 1 | 3 | Yes |
| (1.5%) + Gelatin | | | |
| (3%) + Water (52.5%) | | | |

These data indicate that pectin is necessary for the formulation, but that gelatin, Methocel and Xanthan can be added to the formulation.

### EXAMPLE 3

In this example, experiments were conducted to determine, the minimum amount of Pectin needed in the formula

| | Mixture solution | Gel forming | Proper baked |
|---|---|---|---|
| | scores (1= thin, 3 = | (1= no gel, 3 = | scores (1 = bad, 3 = |
| % Pectin | medium, 5 = thick) | light gel, 5 = gel) | fine, 5 = good) |
| 0.25 | 0.5 | 1 | 1 (not completely |
| | | | cooked) |
| 0.5 | 1.5 | 3 | 3 |
| 0.75 | 3.5 | 5 | 5 |
| 1.0 | 4 | 5 | 5 |

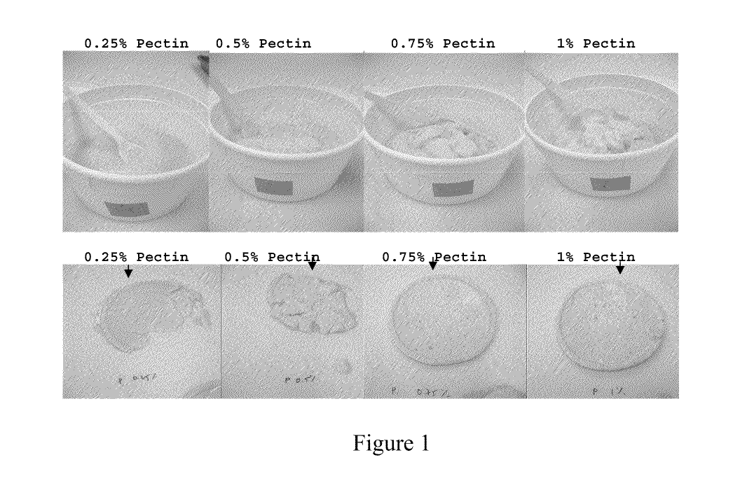

The percentage of Pectin at 0.75 was found to be the minimum amount of pectin or gum required for this invention. It provided a product which was easy to pour and had good baked appearance. In one embodiment, 0.25% of Pectin and 0.25% of Gelatin showed similar performance as 0.5% Pectin—which was outside of the present invention. The results are shown in FIG. 1 which shows uncooked gelled patties for the indicated pectin concentrations.

While the invention is described as specific embodiments, routine modifications to these embodiments will be apparent to those skilled in the art and intended to be within the scope of the present invention.

We claim:

1. A frozen or refrigerated food product comprising a polymer component, an egg component and water, wherein the polymer component comprises at least 0.75% pectin, and the egg component is from 35 to 55% and comprises uncooked liquid eggs or egg substitutes, and wherein the food product is gelled.

2. The frozen or refrigerated food product of claim 1, wherein the polymer component further comprises one or more polymers selected from the group consisting of gelatin, methocil or xantham gum.

3. The frozen or refrigerated food product of claim 2, wherein the pectin is 1.5%, gelatin in 3% and the egg component is 35 to 55%.

4. The frozen or refrigerated food product of claim 1, further comprising cheese.

5. A method for producing a food product:
a) preparing an aqueous solution of a polymer component comprising at least 0.75% pectin;
b) adding liquid uncooked egg component to the solution from a) to form a mixture;
c) allowing the mixture from b) to gel; and
d) storing the gelled product in a freezer or refrigerator.

6. The method of claim 5, further comprising the steps of:
e) removing the gelled product from the freezer or refrigerator and placing said gelled product on a base; and
f) exposing the base and the patty to heat such that the egg component of the gelled product adheres to the base and is cooked.

7. The method of claim 5, wherein the base is selected from the group consisting of muffin, bread, flat bread, pita, pizza crust, calzone and tortilla.

8. The method of claim 5, wherein the pH of the mixture from b) is from 3 to 5.

9. The method of claim 5, wherein the aqueous solution of the polymer component is prepared by adding the polymer component to water, said water being at a temperature of 120 to 180 F.

10. The method of claim 9, wherein the water is at a temperature of from 135 to 185 F.

11. A cooked food product prepared by the method of claim 6.
